(19) United States
(12) Patent Application Publication
(10) Pub. No.: US 2026/0054698 A1
(43) Pub. Date: Feb. 26, 2026

(54) DEPLOYABLE PEDAL ASSEMBLY

(71) Applicant: VENTRA GROUP, CO., Halifax (CA)

(72) Inventors: Ron PRENTICE, Halifax (CA); Khanjan PATEL, Innisfil (CA); Dusit SUKONTHAPANICH, Newmarket (CA)

(21) Appl. No.: 19/301,747

(22) Filed: Aug. 15, 2025

Related U.S. Application Data
(60) Provisional application No. 63/685,941, filed on Aug. 22, 2024.

(51) Int. Cl. B60T 7/06; B60K 26/02

(52) U.S. Cl. CPC B60T 7/06; B60K 26/02; B60K 2026/026

(57) ABSTRACT

A pedal assembly for a vehicle comprises an accelerator pedal assembly having an accelerator pedal arm and an accelerator pedal mounting bracket; a brake pedal assembly having a brake pedal arm and a brake pedal mounting bracket; and an actuator. The actuator is operatively connected to the accelerator pedal assembly and the brake pedal assembly. The actuator is configured to adjust a position of the corresponding pedal arm relative to its corresponding mounting bracket between an operating position for when the vehicle is in the non-autonomous driving mode and a non-operating, stowed position for when the vehicle is in the autonomous driving mode. The non-operating, stowed position is at a raised position with respect to the operating position.

### CROSS-REFERENCE TO RELATED APPLICATIONS

This application claims priority to U.S. Provisional Application No. 63/685,941, filed Aug. 22, 2024.

### BACKGROUND

### Field

The present patent application relates to a pedal assembly for a vehicle.

### Description of Related Art

Actuating assemblies for operating input elements of vehicles are well-known and include assemblies such as pedal assemblies. A pedal, such as a brake pedal, is mounted to a dash panel or a firewall in a passenger compartment of a vehicle so as to provide a driver easy access for operation of the pedal via his/her foot. For example, known brake pedal assemblies include a pedal arm having one end that is pivotally mounted to a mounting structure (e.g., a bracket) provided in the vehicle to enable pivotal movement of the pedal arm about an operating pivot axis. Other pedal assemblies of the vehicle include an accelerator pedal assembly and a clutch pedal assembly.

Adjustable pedal technology is used to extend and retract the pedal arm, but this technology is for comfort/convenience only. Usually, adjustable pedals are to accommodate people with larger or shorter legs/reach.

An autonomous vehicle generally includes sensors and a controller therein to control, navigate, and drive the vehicle without any input from the driver.

It would be advantageous to provide an improved pedal assembly.

### BRIEF SUMMARY

In one embodiment of the present patent application, a pedal assembly for a vehicle is provided. The vehicle is configured to be operated in either a non-autonomous driving mode in which the vehicle is driven by a driver or an autonomous driving mode in which the vehicle is autonomously driven. The pedal assembly comprises an accelerator pedal assembly having an accelerator pedal arm and an accelerator pedal mounting bracket; a brake pedal assembly having a brake pedal arm and a brake pedal mounting bracket; and an actuator. Each of the accelerator pedal arm and the brake pedal arm comprises an elongated lever structure with a first end and a second end; and a pedal plate provided on the second end of the elongated lever structure of the corresponding pedal arm for depression by a foot of the driver. The actuator is operatively connected to the accelerator pedal assembly and the brake pedal assembly. The actuator is configured to adjust a position of the corresponding pedal arm relative to its corresponding mounting bracket between an operating position for when the vehicle is in the non-autonomous driving mode and a non-operating, stowed position for when the vehicle is in the autonomous driving mode. The non-operating, stowed position is at a raised position with respect to the operating position.

These and other aspects of the present patent application, as well as the methods of operation and functions of the related elements of structure and the combination of parts and economies of manufacture, will become more apparent upon consideration of the following description with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise. It should also be appreciated that some of the components and features discussed herein may be discussed in connection with only one (singular) of such components, and that additional like components which may be disclosed herein may not be discussed in detail for the sake of reducing redundancy.

Other aspects, features, and advantages of the present patent application will become apparent from the following detailed description, the accompanying drawings, and the appended claims.

### BRIEF DESCRIPTION OF THE DRAWINGS

Various embodiments are disclosed, by way of example only, with reference to the accompanying schematic drawings in which corresponding reference symbols indicate corresponding parts, in which

FIGS. 1A and 1B show partial views of a vehicle with a pedal assembly installed therein in accordance with an embodiment of the present patent application, wherein FIG. 1A shows the pedal assembly in its operating position and FIG. 1B shows the pedal assembly in its stowed, non-operating position;

FIGS. 2A and 2B show front views of the pedal assembly in accordance with an embodiment of the present patent application, wherein the front view of FIG. 2a shows pedal arms of the pedal assembly in their operating positions and the front view of FIG. 2b shows pedal arms of the pedal assembly in their stowed, non-operating positions;

FIGS. 3A and 3B show side views of the pedal assembly in accordance with an embodiment of the present patent application, wherein the side view of FIG. 3a shows pedal arms of the pedal assembly in their stowed, non-operating positions and the side view of FIG. 3b shows pedal arms of the pedal assembly in their operating positions;

FIG. 4 shows an exploded view of an accelerator pedal assembly in accordance with an embodiment of the present patent application;

FIG. 5A shows an exploded view of a brake pedal assembly in accordance with an embodiment of the present patent application;

FIG. 5B shows a partial assembled view of the brake pedal assembly in accordance with an embodiment of the present patent application;

FIG. 6 shows a front elevational view of the pedal assembly, in its operating, position in accordance with an embodiment of the present patent application;

FIG. 7 shows a front elevational view of the pedal assembly, in its non-operating, stowed position in accordance with an embodiment of the present patent application;

FIG. 8 shows a side elevational view of the pedal assembly, in its non-operating, stowed position, in accordance with an embodiment of the present patent application;

FIG. 9 shows a side elevational view of the pedal assembly, in its operating position, in accordance with an embodiment of the present patent application;

FIG. 10 shows another side elevational view of the pedal assembly, in its operating, position, in accordance with an embodiment of the present patent application;

FIG. 11 shows another side elevational view of the pedal assembly, in its non-operating, stowed position, in accordance with an embodiment of the present patent application;

FIG. 12 shows a front elevational view of the pedal assembly, in its non-operating, stowed position, along with an instrumental panel of the vehicle in accordance with an embodiment of the present patent application;

FIG. 13 shows a front elevational view of the pedal assembly, in its operating position, along with the instrumental panel of the vehicle in accordance with an embodiment of the present patent application;

FIG. 14 shows a perspective view of the pedal assembly, in its operating position, in accordance with an embodiment of the present patent application;

FIG. 15 shows a perspective view of the pedal assembly, in its non-operating, stowed position with a lower part of an outer wall removed to show more of the accelerator pedal arm in the stored position, in accordance with an embodiment of the present patent application;

FIG. 16 shows a perspective view of another embodiment;

FIG. 17 show a different perspective view of the embodiment of FIG. 16;

FIG. 18 shows a perspective of view of the embodiment of FIG. 16 in the deployed or operating position; and

FIG. 19 is the same view as FIG. 18, but in the retracted, stowed position.

### DETAILED DESCRIPTION OF THE DRAWINGS

A pedal assembly 10 configured to activate a functional system (e.g., a brake booster, an engine throttle, or other functional systems) of a vehicle/motor vehicle V is provided. The construction of the motor vehicle, and the vehicle body thereof are not considered to be part of the present patent application and thus will not be detailed herein. Instead, the present patent application is concerned in detail with the pedal assembly 10.

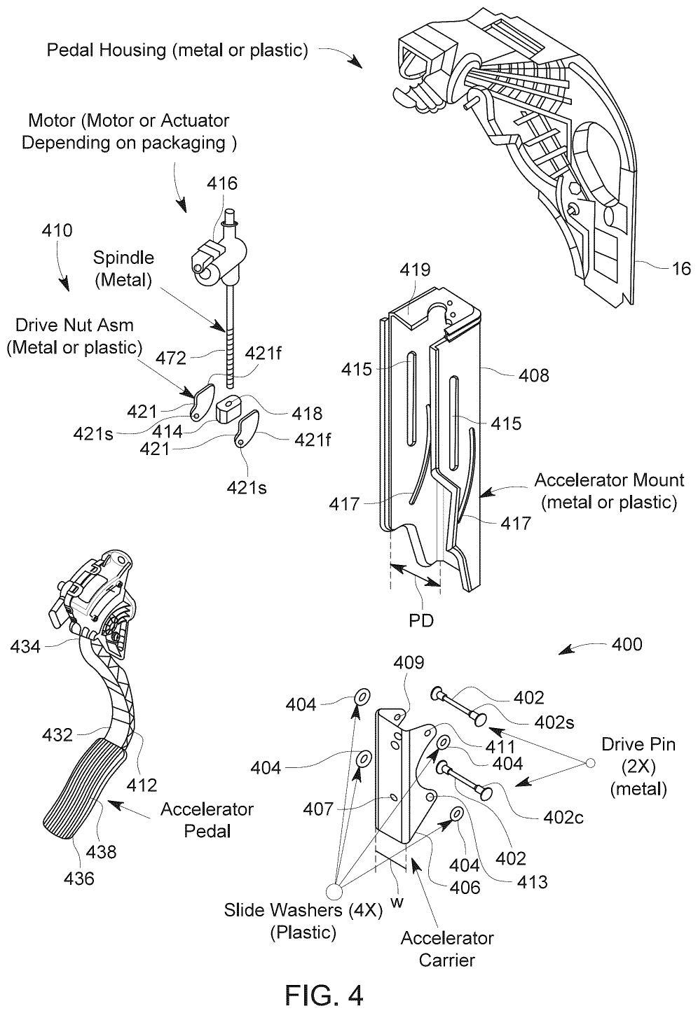

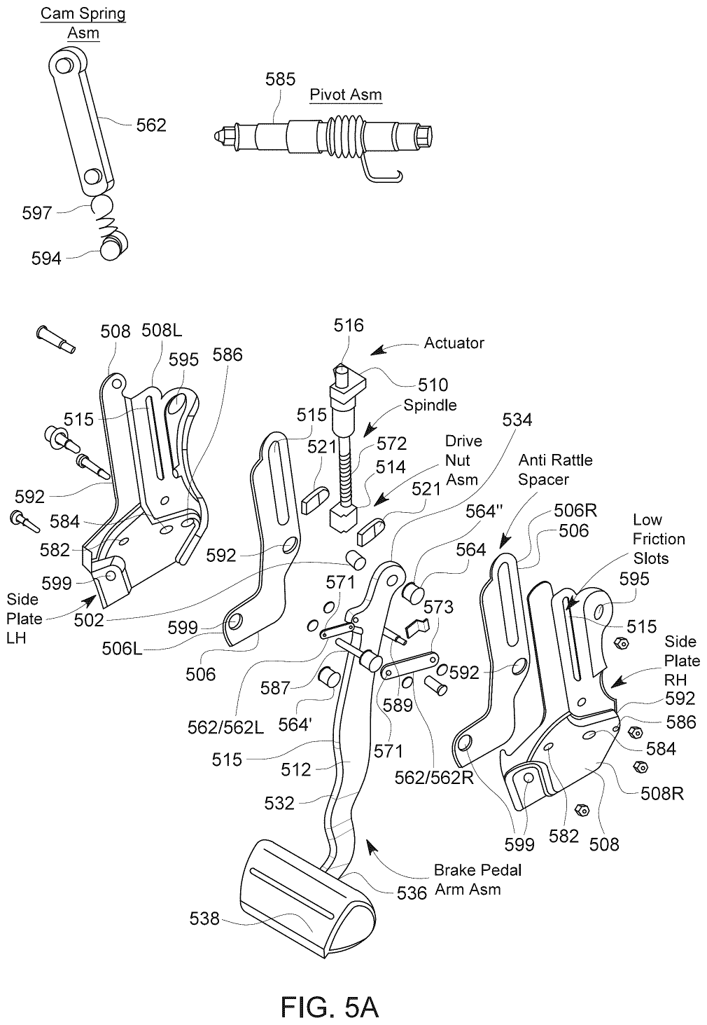

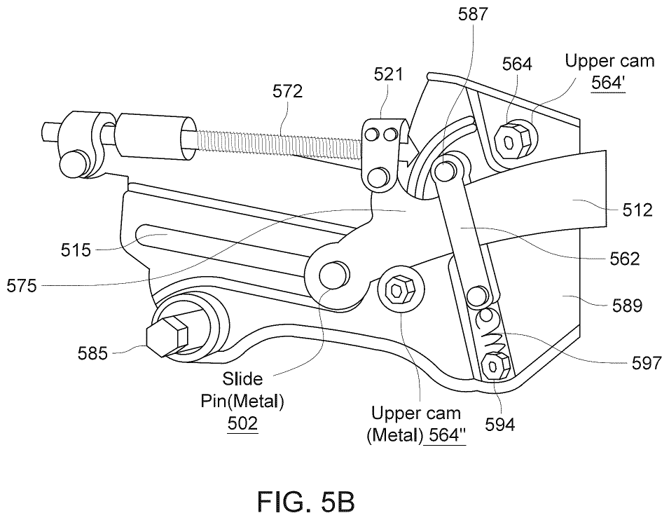

In one embodiment, the pedal assembly 10 for the vehicle V comprises an accelerator pedal assembly 400, a brake pedal assembly 500, and an actuator 410, 510. The accelerator pedal assembly 400 has an accelerator pedal arm 412 and an accelerator pedal mounting bracket 408. The brake pedal assembly 500 has a brake pedal arm 512 and a brake pedal mounting bracket 508. Referring to FIGS. 4 and 5, each of the accelerator pedal arm 412 and the brake pedal arm 512 comprises an elongated lever structure 432, 532 with a first end 434, 534/575 and a second end 436, 536; and a pedal plate 438, 538 provided on the second end 436, 536 of the elongated lever structure 432, 532 of the corresponding pedal arm 412, 512 for depression by a foot F of a driver D. The actuator 410, 510 is operatively connected to the accelerator pedal assembly 400 and the brake pedal assembly 500. The actuator 410, 510 is configured to adjust a position of the corresponding pedal arm 412, 512 relative to its corresponding mounting bracket 408, 508 between an operating position for when the vehicle V is in the non-autonomous driving mode and a non-operating, stowed position for when the vehicle V is in the autonomous driving mode. The non-operating, stowed position is at a raised position with respect to the operating position.

In one embodiment, the first end 575 of the brake pedal arm 512 is operatively connected to the actuator 510 for adjusting a position of the corresponding pedal arm 512 relative to its corresponding mounting bracket 508 between the operating position and the non-operating, stowed position. In one embodiment, the accelerator pedal arm 412 is operatively connected to the actuator 410, using an accelerator pedal carrier member 406, a drive pin 402/402s and a drive connector 421 as will be discussed in detail below, for adjusting a position of the corresponding pedal arm 412 relative to its corresponding mounting bracket 408 between the operating position and the non-operating, stowed position.

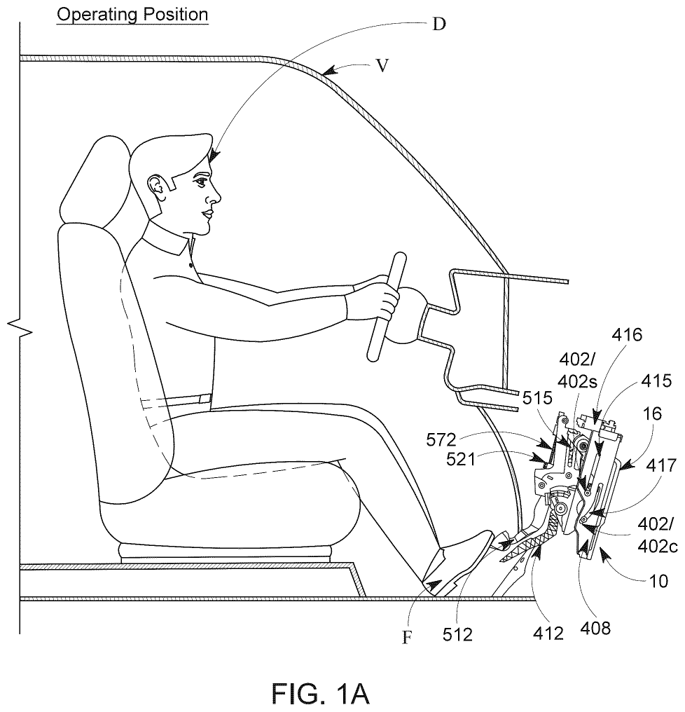

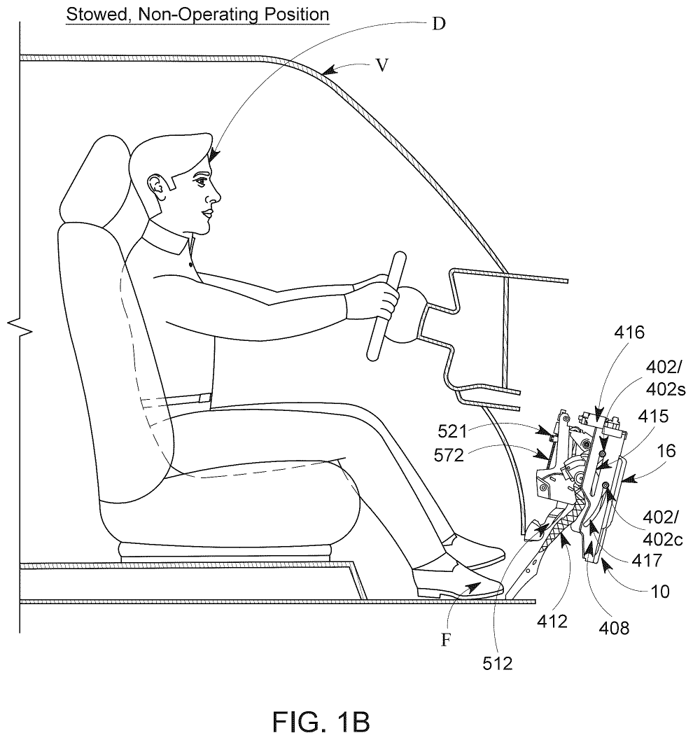

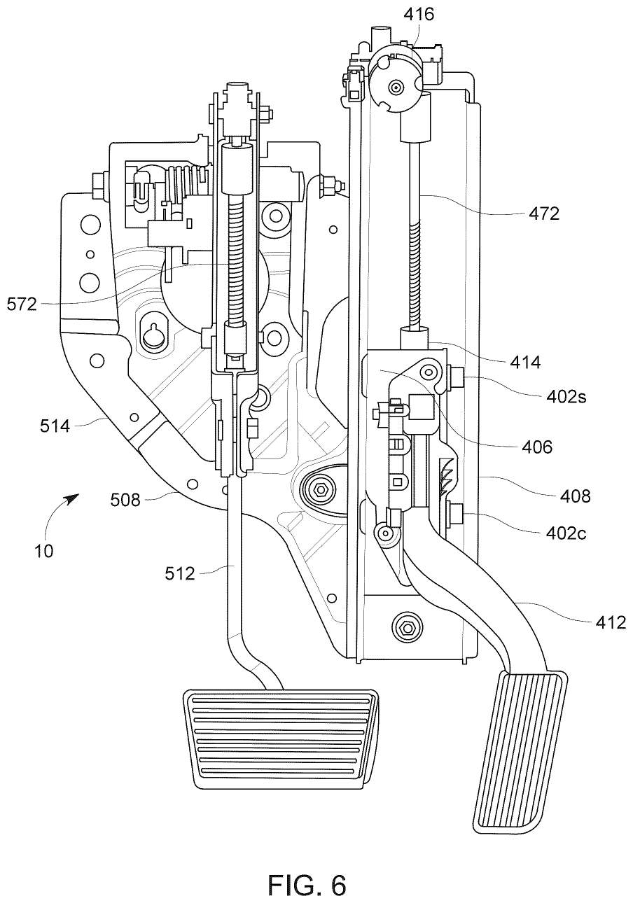

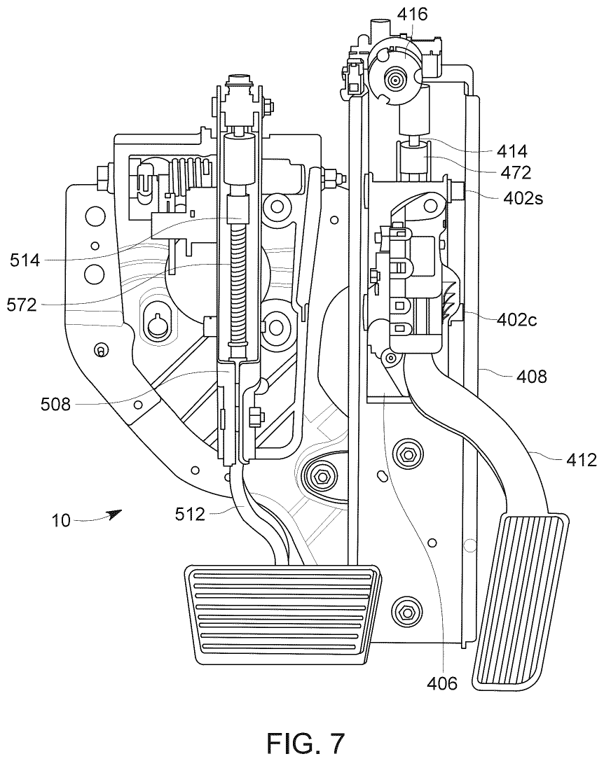

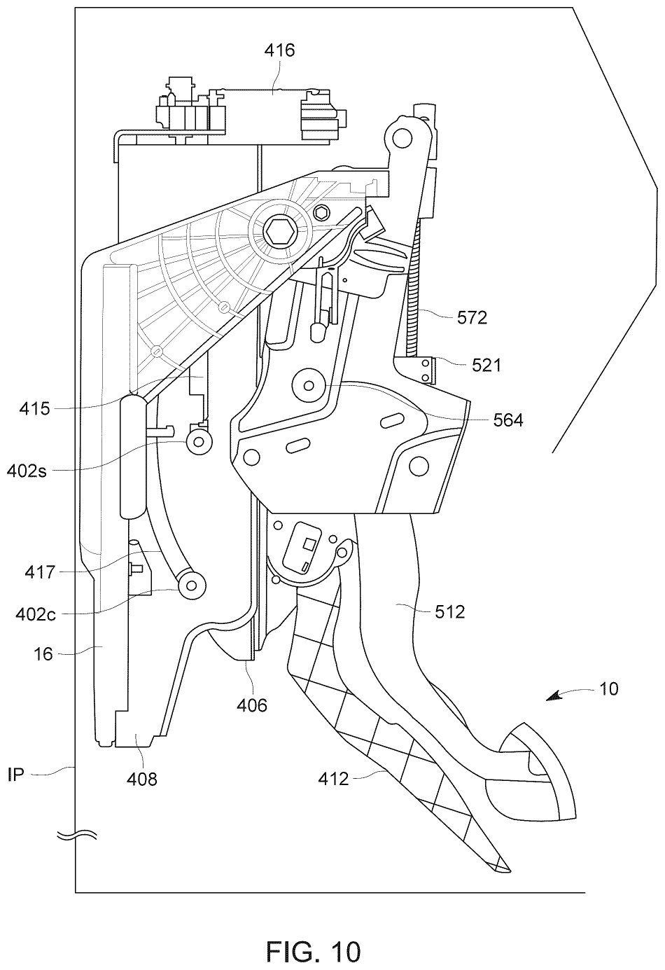

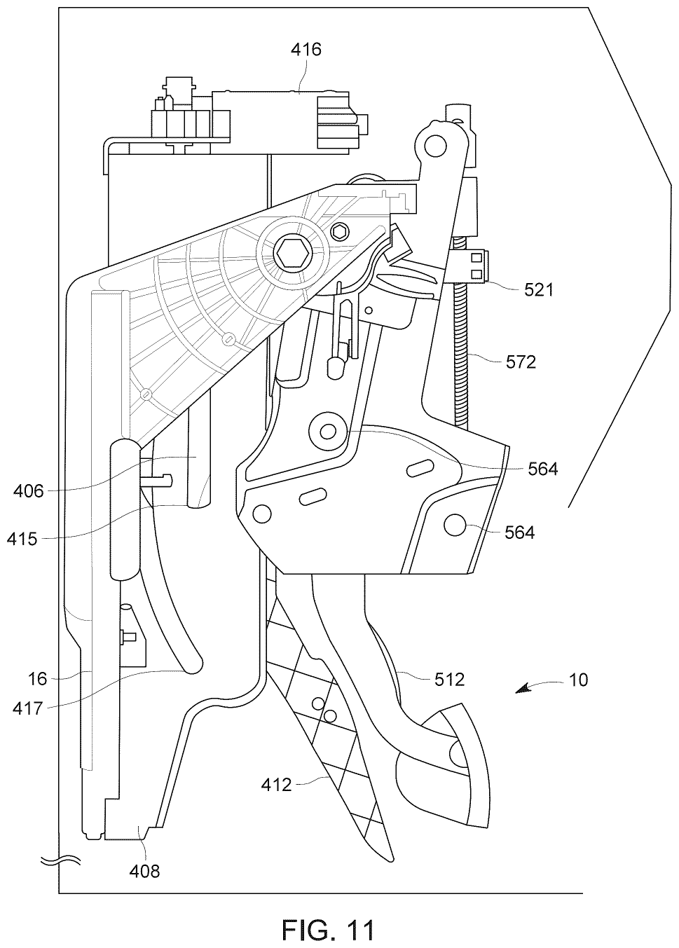

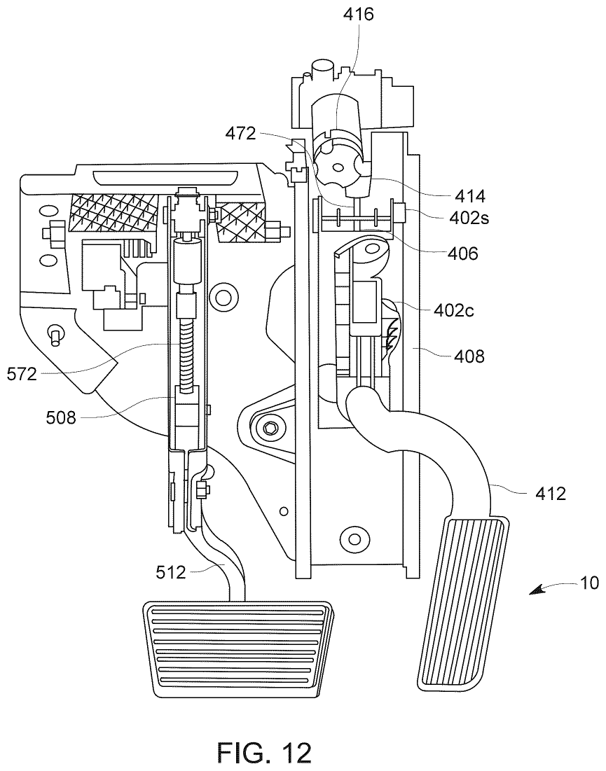

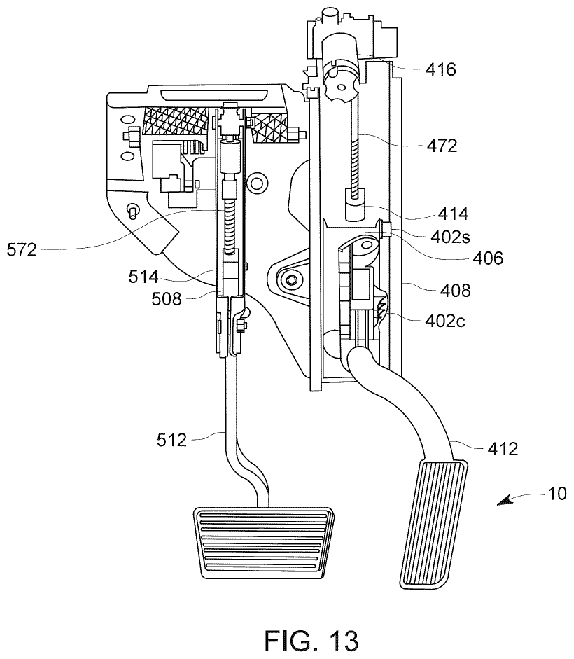

The present patent application generally relates to the pedal assembly 10 for self-driving automobiles (i.e., autonomous or driverless vehicles). The pedal assembly 10 is a deployable pedal assembly. For example, the present patent application relates to the pedal structure/assembly 10 that moves the pedals 412 and 512 between their normal/operating positions for when the vehicle V is in a manual driving mode and their stowed/non-operating positions for when the vehicle V is in a self-driving (i.e., autonomous) mode, for example, to provide the driver D with additional foot space or provide additional space within the vehicle V if unoccupied. That is, the present patent application allows for an additional benefit when the vehicle's pedals 412, 512 are not required for the operation of the vehicle V. In one embodiment, as described in detail below with respect to FIGS. 1a-15, the physical structure of the pedal assembly 10 includes a pedal bracket/housing containing the entire pedal assembly 400, 500, pivot bushings, slot features in the bracket/housing, slide pins, cams, DC motors and actuators that are used to extend and retract the pedals 412, 512 between their normal/operating positions and their stowed/non-operating positions.

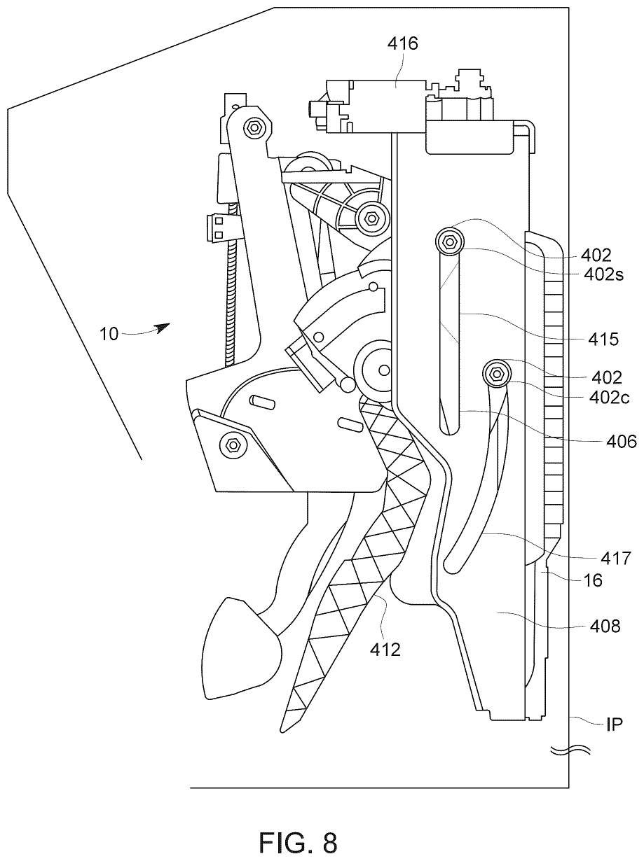

For example, the deployable pedal assembly 10 includes a support structure adapted to connect to the vehicle V. The support structure is configured to define a cam (e.g., 564 and 562 as shown in FIG. 5A) and a slot (e.g., 515 as shown in FIG. 5A) and/or two slots (e.g., 415, 417) arranged in a spaced manner to achieve the pedal positions, that is, to retract and extend the pedal between the driver mode position and the non-driver mode position behind an instrument panel IP (as shown in FIGS. 8-11) of the vehicle V. The linear actuator 410, 510 is connected with the pedal assembly 400, 500 for sliding/moving the pedal assembly 400, 500 to the desired position along the support structure. The linear actuator may be used with the brake pedal and the accelerator pedal. Additional pedals such as a clutch pedal can be incorporated into the design of the present patent application. In one embodiment, the deployable pedal is configured to work with both brake by wire systems and traditional brake booster/vacuum systems. The deployable pedal assembly 10 is configured to retract the pedal behind the instrument panel IP to provide additional foot space for the driver D in the driverless/autonomous vehicle mode.

In one embodiment, the vehicle V is configured to be autonomously driven with little or no input from the driver D (and possibly with no driver present at all). The vehicle V is configured to be operated in either a non-autonomous/driver mode in which the vehicle V is driven by the driver D or an autonomous driving mode in which the vehicle V is autonomously driven. The vehicle V may have other driving modes in addition to the non-autonomous driving mode and the autonomous driving mode. In one embodiment, the vehicle V is configured either to allow the driver D to switch or to automatically switch between the non-autonomous driving mode and the autonomous driving mode.

In one embodiment, in the autonomous driving mode, all vehicle subsystems are fully automated/controlled by the vehicle's controller requiring no human intervention. In another embodiment, in the autonomous driving mode, vehicle subsystems like steering, brakes and throttle are fully automated/controlled by a controller of the vehicle V, and the vehicle V monitors conditions to transition back to the non-autonomous driving mode when/if needed.

In one embodiment, in the non-autonomous driving mode, the driver D controls all the vehicle subsystems of the vehicle V. In another embodiment, in the non-autonomous driving mode, the driver D controls most of the vehicle subsystems of the vehicle V and the vehicle V controls one or more specific vehicle subsystems.

The vehicle V includes sensors that are configured to generate signals that help navigate the vehicle V when the vehicle V is operating in the autonomous mode. The sensors are operatively connected to the controller in the vehicle V. The controller is configured to receive the generated signals and to control the vehicle subsystems when the vehicle V is operating in the autonomous mode, to navigate and drive the vehicle with little or no [without any] input from the driver.

The pedal assembly 10 also includes a vehicle mounting bracket 16. In one embodiment, the vehicle mounting bracket 16 is made of a plastic material. In another embodiment, the vehicle mounting bracket 16 is made of a metal (e.g., steel or other metal) material. In one embodiment, the vehicle mounting bracket 16 is interchangeably referred to as a pedal housing.

The vehicle mounting bracket 16 is a bracket used for mounting the accelerator and brake pedal assemblies 400, 500 to the vehicle structure, using fastening members, and/or in cooperation with other brackets, for connecting the accelerator and brake pedal arms 412, 512 to the vehicle V. In one embodiment, the vehicle mounting bracket 16 may be connected to a part of vehicle structure. The vehicle mounting bracket 16 may be connected to panels of the vehicle (or the dash, in general) using conventional fastening devices such as nuts and bolts, or by other methods such as welding. As such, the mounting of the vehicle mounting bracket 16 to the vehicle is not meant to be limiting. Of course, the devices used and their designs are not meant to be limiting; thus, alternate designs and assemblies for connecting a pedal arm to a vehicle may be used and would not be considered beyond the scope of the present disclosure.

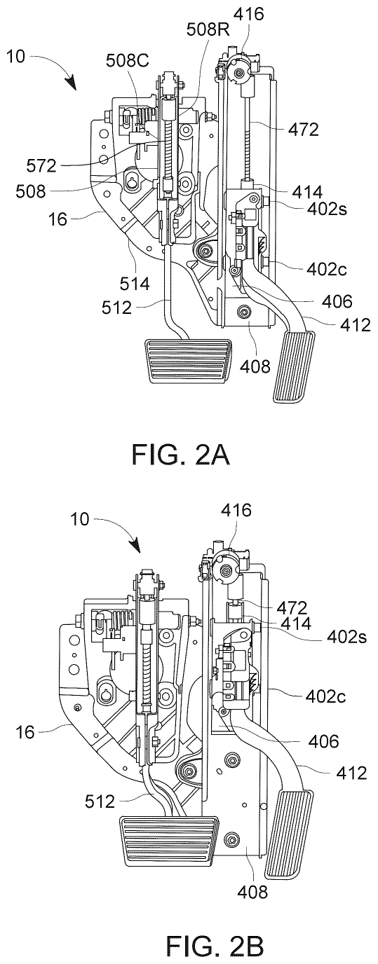

In one embodiment, the operating positions of the accelerator pedal assembly 400 and the brake pedal assembly 500 (i.e., when the vehicle V is in a non-autonomous driving mode) are shown in FIGS. 2a, 3b, 6, 9, 10, 13 and 14 and the non-operating, stowed positions of the accelerator pedal assembly 400 and the brake pedal assembly 500 (i.e., when the vehicle is in an autonomous driving mode) are shown in FIGS. 2b, 3a, 7, 8, 11, 12 and 15. Comparing the operating positions with the non-operating positions in these figures clearly show that the non-operating, stowed positions of the accelerator pedal assembly 400 and the brake pedal assembly 500 are at raised (i.e., higher) positions with respect to the operating positions of the accelerator pedal assembly 400 and the brake pedal assembly 500. The raised/higher configuration of that the non-operating, stowed positions of the accelerator pedal assembly 400 and the brake pedal assembly 500 provide the driver D with additional foot space, for example, when the vehicle's pedals 412, 512 are not required for the operation of the vehicle V.

FIG. 4 shows an exploded view of the accelerator pedal assembly 400. The accelerator pedal assembly 400 acts a control that is used by the driver D to regulate an engine's power. That is, the accelerator pedal assembly 400 is configured to provide a means for controlling the engine's power by regulating the amount of air or fuel entering the engine. In another embodiment, when the vehicle is an electric vehicle, the accelerator pedal assembly 400 is configured to provide a means for controlling the electric power, for example, increase/decrease power from the battery to the motor in accordance with the driver's accelerator request. The accelerator pedal assembly 400 is operatively connected to an engine throttle (i.e., functional system of the vehicle).

In one embodiment, the accelerator pedal assembly 400 is configured to communicate via mechanical connection, wired electrical connection (i.e., signals sent over hardwire circuitry) or wireless communication (e.g., signals) with the engine throttle or a device that controls air intake to the engine, fuel intake to the engine, etc. The term wire in some contexts may also be used to describe mechanical connections as well (e.g., a cable actuated system is often called a drive by wire approach). In one embodiment, there may be no mechanical connection to the functional system of the vehicle. Also, in such an embodiment, the accelerator pedal assembly 400 (i.e., with no mechanical connection) may include a (return) spring to return the accelerator pedal 412 to its home position (i.e., operating, undepressed position). A torsion type return spring may be pivotally mounted about the pivot member, with one end being fixed to the accelerator pedal carrier member 406 and the other end being fixed to the accelerator pedal 412. Alternatively, an extension type return spring may be mounted directly to a hole on the accelerator pedal carrier member 406 on one end, and to another feature on the pedal arm 412 such as a hole or tab. The operation of the accelerator pedal assembly 400 and the engine throttle is known in the art and will not be described in detail here.

The accelerator pedal assembly 400 is provided in the vehicle V such that it is easily accessible by the driver D, for example, via depression by the foot F of the driver D. For example, in some cases, the accelerator pedal assembly 400 is mounted in relation to panels of a dashboard and/or the instrument panel IP. The dashboard of the vehicle, also referred to as the “dash,” may comprise an upper panel and a lower panel that are connected to each other (e.g., using methods or devices known in the art). In some embodiments, the upper dash panel and lower dash panel may comprise a uniform or single piece. The panels are generally connected to a plurality of devices of the vehicle V. For example, the dash may be connected to another vehicle structure, sometimes referred to as a front of dash (on a lower side or underside) or a firewall.

The accelerator pedal assembly 400 includes drive pins 402 (402s, 402c), washers 404, the accelerator pedal carrier member 406, the accelerator pedal arm 412, and the accelerator pedal mounting bracket 408.

The accelerator pedal arm 412 comprises the elongated lever structure 432 with the first (upper) end 434 and the second (lower) end 436. The accelerator pedal plate 438 is provided on the second end 436 of the elongated lever structure 432 of the accelerator pedal arm 412 for depression by the foot F of the driver D of the vehicle V. In one embodiment, the accelerator pedal arm 412 is made of a metal (e.g., steel) material. In one embodiment, the accelerator pedal arm 412 and its accelerator pedal plate 438 are welded together. In one embodiment, the accelerator pedal arm 412 is interchangeably referred to as an accelerator pedal and the accelerator pedal plate 438 is interchangeably referred to as a pedal pad.

The accelerator pedal arm 412 is configured for movement between a first arm position and a second arm position. In one embodiment, the first arm position is a home position where the accelerator pedal 412 is undepressed and the second arm position is a depressed position. In one embodiment, the accelerator pedal arm 412 is configured to have one or more intermediate positions between the first arm position and the second arm position.

The operating position of the accelerator pedal assembly 400 refers to a position in which the driver D of the vehicle V may apply force via his foot F on the pedal plate 438 (or part at the second/distal end 436 of the elongated lever structure 432 that is accessible by the foot F of the driver D) to activate a functional system (i.e., engine throttle) of the vehicle V. The force from the driver's foot F is configured to cooperate with the engine throttle to translate pivotal motion of the accelerator pedal 412 to control acceleration and speed of the vehicle V. Such methods for controlling acceleration and speed of the vehicle V (and the pivotal translation) are known in the art and therefore not discussed in detail herein. In one embodiment, the operating position of the accelerator pedal assembly 400 includes the first arm position of the accelerator pedal arm 412, the second arm position of the accelerator pedal arm 412 and the one or more intermediate positions therebetween.

The stowed, non-operating position of the accelerator pedal assembly 400 refers to a position in which the accelerator pedal assembly 400 is stowed behind the instrument panel IP of the vehicle V. That is, in the stowed, non-operating position, the pedal plate 438 (or part at the second/distal end 436 of the elongated lever structure 432) is not readily accessible to the driver D to activate a functional system (e.g., the engine throttle) of the vehicle V.

The accelerator pedal mounting bracket 408 is connected to the vehicle mounting bracket 16 using conventional fastening devices such as nuts and bolts, or by other methods such as welding. The accelerator pedal mounting bracket 408 includes guides/slots 415, 417 that are configured to enable the accelerator pedal carrier member 406 (with the accelerator pedal 412 mounted thereon) to move between a first position in which the accelerator pedal 412 is positioned in its stowed, non-operating position and a second position in which the accelerator pedal 412 is positioned in its operating position.

The accelerator pedal mounting bracket 408 includes a first pair of aligned, elongated slots 415 that is configured to receive the drive pin/member 402/402s therethrough and a second pair of aligned, elongated slots 417 that is configured to receive the drive pin/member 402/402c therethrough. The first pair of aligned, elongated slots 415 has a substantially straight configuration and the second pair of aligned, elongated slots 417 has a substantially curved configuration. At least a portion of the first pair of aligned, elongated slots 415 extends and is disposed/positioned above/higher than the second pair of aligned, elongated slots 417. Each slot of the first pair of aligned, elongated slots 415 is disposed on opposite, side walls of the accelerator pedal mounting bracket 408 and each slot of the second pair of aligned, elongated slots 417 is disposed on opposite, side walls of the accelerator pedal mounting bracket 408.

The side walls of the accelerator pedal mounting bracket 408 are spaced apart to accommodate the accelerator pedal carrier member 406 (with the accelerator pedal 412 mounted thereon) and the drive pins 402, 402s, 402C therebetween. That is, the side walls of the accelerator pedal mounting bracket 408 are spaced apart by a predetermined distance PD that is greater than the width W of the accelerator pedal carrier member 406.

The accelerator pedal mounting bracket 408 includes a top wall 419 that is configured and shaped to support a motor 416 of the actuator 410 thereon and to allow a lead screw 472 of the actuator 410 to pass therethrough. The details of the actuator 410 are provided in the discussions below.

The accelerator pedal carrier member 406 includes an accelerator pedal side 407 and an accelerator mount side 409 (i.e., opposite to the accelerator pedal side 407). The accelerator pedal arm 412 is connected to the accelerator pedal carrier member 406, on its accelerator pedal side 407, using conventional fastening devices such as nuts and bolts, or by other methods such as welding.

The accelerator pedal structure 432 is pivotally connected to the accelerator pedal carrier member 406 via a pivot member. The pivot member is configured for pivoting the accelerator pedal arm 412 relative to the accelerator pedal carrier member 406 about a pivot axis. The first end 434 of the pedal arm 412 is operatively connected to the pivot member to provide pivotal movement to the pivot member/pin during movement of the accelerator pedal arm 412 between the first arm position and the second arm position.

On the accelerator mount side 409, the accelerator pedal carrier member 406 includes a first pair of aligned openings 411 that is configured to receive the drive pin/member 402/402s therethrough and a second pair of aligned openings 413 that is configured to receive the drive pin/member 402/402c therethrough. The first pair of aligned openings 411 and the second pair of aligned openings 413 may be formed on cut out portions of the accelerator pedal carrier member 406 that forms tabs or ears. The first pair of aligned openings 411 and the second pair of aligned openings 413 are vertically spaced apart from each other such that the first pair of aligned openings 411 is positioned/disposed above the second pair of aligned openings 413. Each opening of the first pair of aligned openings 411 is disposed on opposite, side walls of the accelerator pedal carrier member 406 and each opening of the second pair of aligned openings 413 is disposed on opposite, side walls of the accelerator pedal carrier member 406.

In one embodiment, the accelerator pedal carrier member 406 and the accelerator pedal mounting bracket 408 are made of a plastic material. In another embodiment, the accelerator pedal carrier member 406 and the accelerator pedal mounting bracket 408 are made of a metal material. In one embodiment, the accelerator pedal mounting bracket 408 is interchangeably referred to as an accelerator mount. In one embodiment, the accelerator pedal carrier member 406 is interchangeably referred to as an accelerator carrier.

In one embodiment, the accelerator pedal assembly 400 includes the actuator 410. The actuator 410 may be a linear actuator. In one embodiment, the actuator 410 includes the lead screw 472, a lead nut 414, and the motor 416. The linear actuator 410 may include a gear mechanism. The gear mechanism is connected to the motor to reduce the speed of the motor output while increasing the output torque. The motor is configured to rotate either clockwise or counter-clockwise direction so as to raise or to lower the accelerator pedal arm 412. The motor 416 is configured (e.g., mechanically connected) to rotate the lead screw/spindle 472. The motor 416 may also be configured to be indirectly connected, e.g., through a series of gears or a gearbox, to rotate the lead screw 472. That is, the lead screw 472 is driven by the motor 416. In one embodiment, the lead screw/spindle 472 is made of metal material. In one embodiment, the lead nut 414 is made of a metal material. In another embodiment, the lead nut 414 is made of a plastic material or any other suitable material.

The lead screw 472 is configured to pass through an opening 418 of the lead nut/drive nut 414. The lead screw 472 includes threads machined on its outer surface and extending along its length. The lead nut 414 is constructed and arranged to be threaded onto the lead screw 472 and includes complimentary threads machined on its inner surface. The actuator 410 is configured to prevent the rotation of the lead nut 414 along with the lead screw 472. That is, the lead nut 414 is restrained from rotating along with the lead screw 472, therefore the lead nut 414 is configured to travel up and down the lead screw 472. When the lead screw 472 is rotated by the motor 416, the lead nut 414 is driven along the threads.

The accelerator pedal assembly 400 also includes the drive connectors 421. In one embodiment, the accelerator pedal assembly 400 includes two connectors 421, each positioned on one side of the drive/lead nut 414. Each connectors 421 has a first end 421f connected to the lead nut 414 and a second end 421s connected to the drive pin 402/402s. The second ends 421s of each connector 421 include openings to receive drive pin 402/402s therethrough. The connectors are configured to transmit the movement of the lead nut 414 to the accelerator pedal carrier member 406 via the drive pin 402, 402S. That is, a portion of the drive pin 402/402s is operatively connected to the lead nut 414 to enable the movement of the accelerator pedal carrier member 406 so as to position the accelerator pedal arm 412 at its operating position (as shown in FIGS. 2a, 3b, 6, 9, 10, 13, 14) lowered and extended towards the driver D, at its stowed, non-operating position (as shown in FIGS. 2b, 3a, 7, 8, 11, 12, and 15), and one or more intermediate positions therebetween. These intermediate positions may include additional operating positions where the pedal arm 412 is not completely extended and lowered, thus accommodating persons of differing leg length and/or seat height or position.

When the accelerator pedal assembly 400 is in an assembled configuration, the first pair of aligned, elongated slots 415 of the accelerator pedal mounting bracket 408 is aligned with the first pair of aligned openings 411 of the accelerator pedal carrier member 406 and both the aligned pairs are configured to together receive the drive pin 402/402s therethrough. The drive pin 402/402s is also configured to pass through the openings of the connectors 421 to operatively connect the drive pin 402/402s to the lead nut 414. Also, when the accelerator pedal assembly 400 is in the assembled configuration, the second pair of aligned, elongated slots 417 of the accelerator pedal mounting bracket 408 is aligned with the second pair of aligned openings 413 of the accelerator pedal carrier member 406 and both the aligned pairs are configured to receive the drive pin 402/402c therethrough.

When the actuator 410 is actuated/operated, the lead screw 472 is rotated by the motor 416 and the lead nut 414 (along with the connectors 421 connected thereto) is driven along the threads. This movement of the lead nut 414 is transmitted to the accelerator pedal carrier member 406 via the drive pin 402, 402s and the connectors 421. That is, the movement of the lead nut 414 causes the drive pin 402, 402s (and an upper portion of the accelerator pedal carrier member 406 connected to the drive pin 402, 402s) to slide along the first pair of aligned, elongated slots 415 of the accelerator pedal mounting bracket 408. The movement of the upper portion of the accelerator pedal carrier member 406 in turn causes the drive pin 402, 402c (and a lower portion of the accelerator pedal carrier member 406 connected to the drive pin 402, 402c) to slide along the second pair of aligned, elongated slots 417 of the accelerator pedal mounting bracket 408.

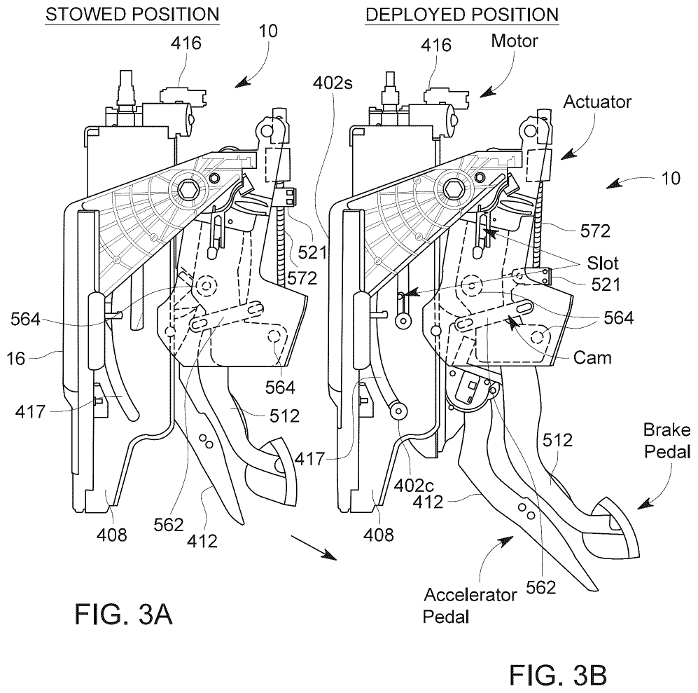

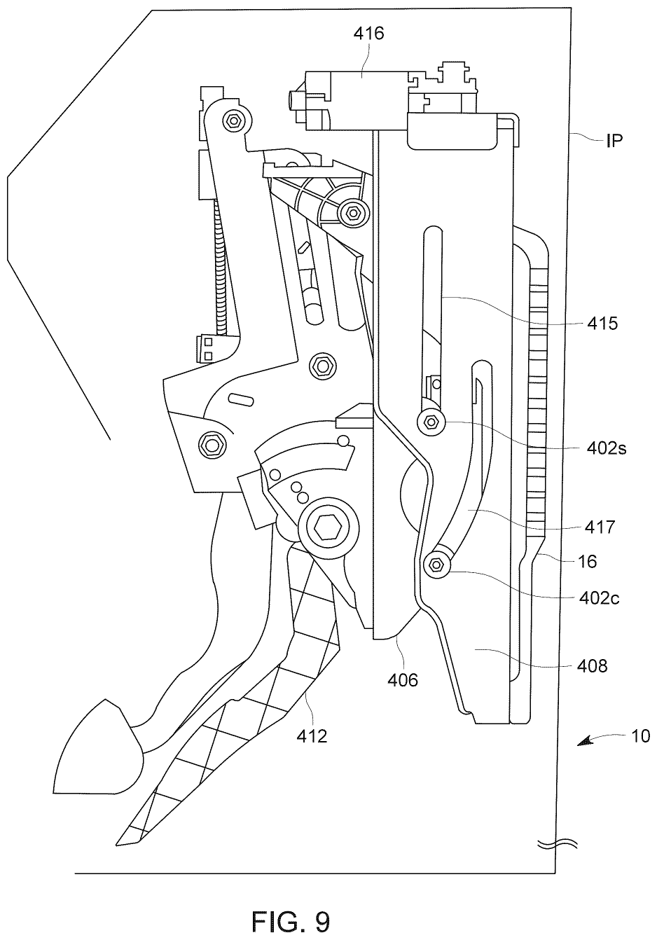

The sliding movement of the drive pins 402s and 402c (and the accelerator pedal carrier member 406 connected to the drive pin 402s, 402c) along the first and second pair of aligned, elongated slots 415, 417 of the accelerator pedal mounting bracket 408 enables the movement of the accelerator pedal 412 (attached/connected to the accelerator pedal carrier member 406) between the operating position and the stowed, non-operating position. Comparing and referring to FIGS. 3a and 3b and also FIGS. 8 and 9, the curved configuration of the elongated slots 417 assists with the tilt of the accelerator pedal carrier member 406 (and the accelerator pedal 412 attached/connected thereto) so as to extend the accelerator pedal 412 and its pedal plate 438 toward the driver D when the pedal assembly 400 is in its operational position.

Referring to FIGS. 2a, 3b, 6, 9, 10, 13, and 14, in the operating position of the accelerator pedal 412, the lead nut 414 is moved/positioned to be at/near a lower end position of the lead screw 472 and the drive pins 402c, 402s are moved/positioned to be at/near lower end positions of their corresponding first and the second pair of aligned, elongated slots 415, 417 of the accelerator pedal mounting bracket 408. Referring to FIGS. 2b, 7, 8, 12, and 15 in the stowed, non-operating position of the accelerator pedal 412, the lead nut 414 is moved/positioned to be at/near an upper end position of the lead screw 472 and the drive pins 402c, 402s are moved/positioned to be at/near the upper end positions of their corresponding first and the second pair of aligned, elongated slots 415, 417 of the accelerator pedal mounting bracket 408.

FIG. 5A shows an exploded view of the brake pedal assembly 500 and FIG. 5B shows a partial assembled view of portions of the brake pedal assembly 500. The brake pedal assembly 500 is configured to be operatively connected to a brake booster (not shown). The brake pedal assembly 500 is provided in the vehicle V such that it is easily accessible by the driver D, for example, via depression by the foot F of the driver D. For example, in some cases, the brake pedal assembly 500 is mounted in relation to panels of the dashboard and/or instrument panel.

The brake pedal assembly 500 includes brake pedal mounting bracket 508 (508L, 508R), anti-rattle members 506 (506L, 506R), the brake pedal arm 512, slide pin 502, cam members 562, and cams 564. The brake pedal mounting bracket 508 (508L, 508R) may be made of a metal (e.g., steel) material or any suitable material. The anti-rattle members 506 (506L, 506R) may also be referred to as shims. The cam members 562 may also be referred to as pedal arm guides.

The brake pedal arm 512 comprises the elongated lever structure 532 with the first (upper) end 534 and the second (lower) end 536. The brake pedal plate 538 is provided on the second end 536 of the elongated lever structure 532 of the brake pedal arm 512 for depression by the foot F of the driver D of the vehicle V. In one embodiment, the brake pedal arm 512 is made of a metal (e.g., steel) material. In one embodiment, the brake pedal arm 512 and its brake pedal plate 538 are welded together. In one embodiment, the brake pedal arm 512 is interchangeably referred to as a brake pedal and the brake pedal plate 538 is interchangeably referred to as a pedal pad.

The brake pedal arm 512 is configured for movement between a first arm position and a second arm position. In one embodiment, the first arm position is a home position where the brake pedal is undepressed and the second arm position is a depressed position. In one embodiment, the brake pedal arm 512 is configured to have one or more intermediate positions between the first arm position and the second arm position.

The operating position of the brake pedal assembly 500 refers to a position in which the driver D of the vehicle V may apply force via his foot F on the pedal plate 538 (or part at the second/distal end 536 of the elongated lever structure 532 that is accessible by the foot F of the driver D) to activate a functional system (e.g., brake booster of the brake system) of the vehicle. The force from the driver's foot F causes pivotal motion of the brake pedal 512 in the depressing direction and the brake pedal 512 cooperates with brake booster to translate that into a braking force to be applied to the wheels of the vehicle. Such methods for applying a braking force (and the pivotal translation) are known in the art and therefore not discussed in detail herein.

In one embodiment, the operating position of the brake pedal assembly 500 includes the first arm position of the brake pedal arm 512, the second arm position of the brake pedal arm 512 and the one or more intermediate positions therebetween.

The stowed, non-operating position of the brake pedal assembly 500 refers to a position in which the brake pedal assembly 500 is stowed behind the instrument panel IP of the vehicle V. That is, in the stowed, non-operating position, the pedal plate 538 (or part at the second/distal end 536 of the elongated lever structure 532) is not readily accessible to the driver D to activate a functional system (e.g., the brake booster) of the vehicle V.

The brake pedal arm 512 is pivotally connected to the vehicle mounting bracket 16 via a pivot pin 585. The pivot pin 585 is received in openings 595 of the brake pedal mounting bracket 508 and openings of the vehicle mounting bracket 16. The pivot pin 585 is configured for pivoting the brake pedal mounting bracket 508 (and the brake pedal arm 512 connected thereto, as will be clear from the detailed discussions below) relative to the vehicle mounting bracket 16 during movement of the brake pedal arm 512 between the first arm position and the second arm position.

In one embodiment, the brake pedal assembly 500 is configured to communicate via mechanical connection, via wired connection or wireless communication with the brake booster, similarly to the accelerator pedal arm as mentioned previously. In one embodiment, there may be no mechanical connection to a functional system of the vehicle. Also, in such an embodiment, the brake pedal assembly 500 (i.e., with no mechanical connection) may include a (return) spring to return the brake pedal 512 to its home position (i.e., operating, undepressed position). A torsion type return spring may be pivotally mounted about the pivot member, with one end being fixed to the vehicle mounting bracket 16 and the other end being fixed to the brake pedal mounting bracket 508 (and the brake pedal arm 512 connected thereto). Alternatively, an extension type return spring may be mounted directly to a hole on the vehicle mounting bracket 16 on one end, and to another feature on the brake pedal mounting bracket 508 (and the brake pedal arm 512 connected thereto) such as a hole or tab. The operation of the brake pedal assembly 500 and the brake booster is known in the art and will not be described in detail here.

Each of the brake pedal mounting bracket 508 (508L, 508R) and optional anti-rattle members 506 (506L, 506R) have elongated slots/openings 515. The elongated slots/openings 515 are configured to align with each other and are configured to slidably receive the slide pin 502 therein during the movement of the brake pedal arm 512 between its operating position (as shown in FIGS. 2a, 3b, 6, 9, 10, 13, 14) for when the vehicle V is in a non-autonomous driving mode and its non-operating, stowed position (as shown in FIGS. 2b, 3a, 7, 8, 11, 12, and 15) for when the vehicle is in an autonomous driving mode. In one embodiment, the anti-rattle members are anti-rattle spacers. The slide pin 502 may be made of a metal (e.g., steel) material or any other suitable material.

The left brake pedal mounting bracket 508L, the left cam member 562L and the left anti-rattle member 506L are positioned/disposed on the left side of the brake pedal arm 512, while the right brake pedal mounting bracket 508R, the right cam member 562R and the right anti-rattle member 506R are positioned/disposed on the right side of the brake pedal arm 512.

The cam members 562 (562L, 562R) and the cams 564 (564′, 564″) are configured to facilitate guided or controlled movement of the brake pedal arm 512 between its operating position and its non-operating, stowed position. The cams 564 (564′, 564″) may be made of a metal (e.g., steel) material or any other suitable material.

Portions of the brake pedal arm 512 are configured to engage and to be guided along surfaces of the cams 564 (564′, 564″) during the movement of the brake pedal arm 512 between its operating position and its non-operating, stowed position. Portions of the cam 564″ may be received through aligned openings 592 of each of the brake pedal mounting bracket 508 (508L, 508R) and anti-rattle members 506 (506L, 506R), and portions of the cam 564′ are received through aligned openings 599 of each of the brake pedal mounting bracket 508 (508L, 508R) and anti-rattle members 506 (506L, 506R). Portions of the cams 564′, 564″ may be configured to connect the brake pedal mounting bracket 508 (508L, 508R) and anti-rattle members 506 (506L, 506R) to each other.

Each of the cam members 562L and 562R have openings 571 and 573. Each of the brake pedal mounting bracket 508L and 508R have elongated openings 582 and 584. The cam members 562L and 562R are connected to each other with portions of the brake pedal arm 512 received therebetween. The cam members 562L and 562R are also connected to the brake pedal mounting bracket 508L and 508R. That is, the openings 571 of each of the cam members 562L and 562R are aligned with the elongated openings 582 of each of the brake pedal mounting bracket 508L and 508R to receive connectors therein and the openings 573 of each of the cam members 562L and 562R are aligned with the elongated openings 584 of each of the brake pedal mounting bracket 508L and 508R to receive connectors therein so as to connect the cam members 562L and 562R to each other (with portions of the brake pedal arm 512 received therebetween) and to the brake pedal mounting bracket 508L and 508R.

The cam members 562L and 562R are also connected to the brake pedal mounting bracket 508L and 508R via spring(s) 597 and a connector 594 received in openings 586 of the brake pedal mounting bracket 508L and 508R.

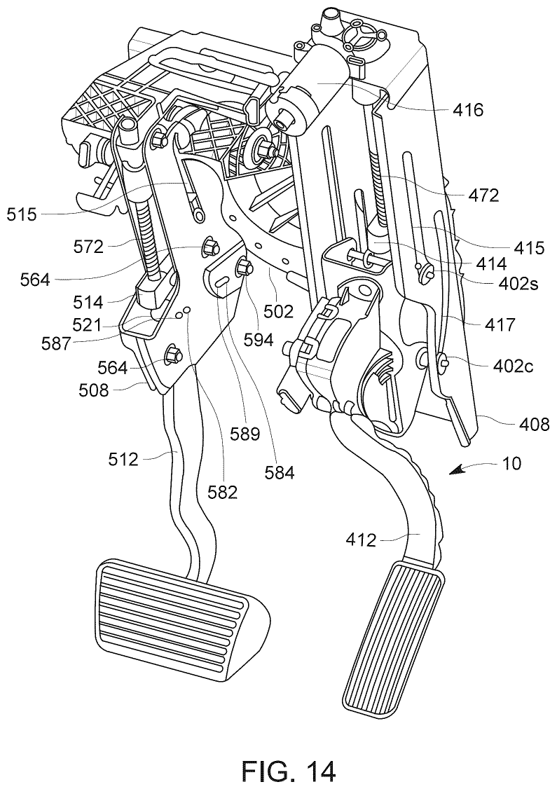

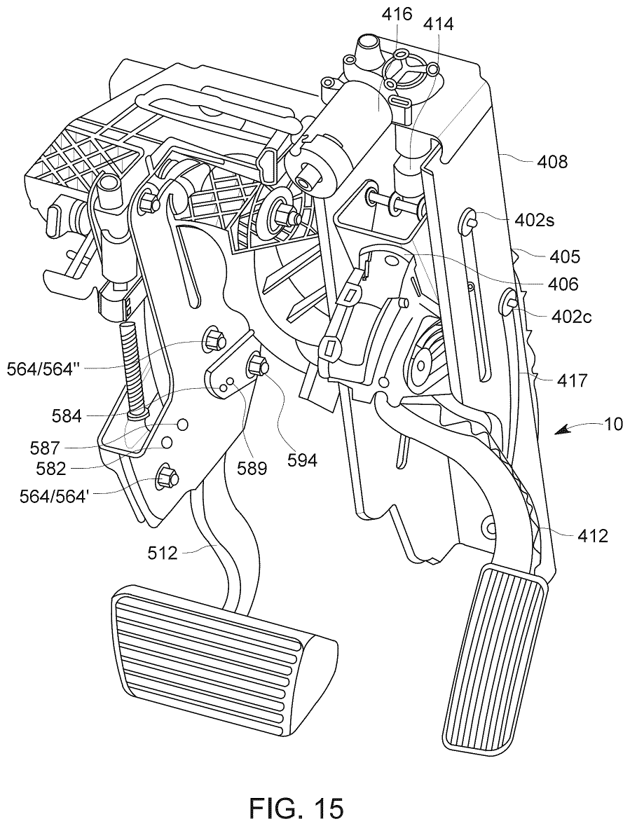

The direction of elongation for the openings 582, 584 (which may be referred to as slots) is lateral or transverse to the pedal arm 512 and allows for shifting movement of the cam members 562L and 56R. Thus, the spring(s) 597, the elongated openings 582 and 584 of the of each of the brake pedal mounting bracket 508L and 508R, connectors 587 (as shown in FIGS. 14-15 and connecting aligned openings 571 of each of the cam members 562L and 562R with the elongated openings 582 of each of the brake pedal mounting bracket 508L and 508R), and connectors 589 (as shown in FIGS. 14-15 and connecting aligned openings 573 of each of the cam members 562L and 562R with the elongated openings 584 of each of the brake pedal mounting bracket 508L and 508R) are together configured to allow for lateral movement of the cam members 562L and 562R (i.e., with the brake pedal arm 512 therebetween) during the movement of the brake pedal arm 512 between its operating position and its non-operating, stowed position.

Slide pin 502 is configured to be received in and slidably moved in the aligned elongated slot 515 of the brake pedal mounting bracket 508 (508L, 508R) and anti-rattle members 506 (506L, 506R) during the movement of the brake pedal arm 512 between its operating position and its non-operating, stowed position. In one embodiment, the elongated slots 515 are configured to be low friction slots.

The brake pedal assembly 500 includes drive connectors 521. In one embodiment, the brake pedal assembly 500 includes two connectors 521, each positioned on one side of the drive/lead nut 514. Each connector 521 has a first end connected to the lead nut 514 and a second end connected to first end portion 575 of the brake pedal arm 512.

In one embodiment, the brake pedal assembly 500 includes the actuator 510. The actuator 510 may be a linear actuator. In one embodiment, the actuator 510 includes the lead screw 572, and a lead nut 514. The actuator 510 may include a motor 516. The linear actuator 510 may include a gear mechanism. The gear mechanism is connected to the motor to reduce the speed of the motor output while increasing the output torque. The motor is configured to rotate either clockwise or counter-clockwise direction so as to raise or to lower the brake pedal arm 512. The motor 516 is configured (e.g., mechanically connected) to rotate the lead screw/spindle 572. The motor 516 may also be configured to be indirectly connected, e.g., through a series of gears or a gearbox, to rotate the lead screw 572. That is, the lead screw 572 is driven by the motor 516. In one embodiment, the lead screw/spindle 572 is made of a metal material. In one embodiment, the lead nut 514 is made of a metal material. In another embodiment, the lead nut 514 is made of a plastic material.

The lead screw 572 is configured to pass through an opening 518 of the lead nut/drive nut 514. The lead screw 572 includes threads machined on its outer surface and extending along its length. The lead nut 514 is constructed and arranged to be threaded onto the lead screw 572 and includes complimentary threads machined on its inner surface. The actuator 510 is configured to prevent the rotation of the lead nut 514 along with the lead screw 572. That is, the lead nut 514 is restrained from rotating along with the lead screw 572, therefore the lead nut 514 is configured to travel up and down the lead screw 572. When the lead screw 572 is rotated by the motor 516, the lead nut 514 is driven along the threads.

When the actuator 510 is actuated/operated, the lead screw 572 is rotated by the motor 516 and the lead nut 514 (along with the connectors 521 connected thereto) is driven along the threads. This movement of the lead nut 514 is transmitted to the brake pedal arm 512 via the connectors 521.

Also, the movement of the lead nut 414 causes the slide pin 502 (and an upper portion of the brake pedal arm 512 connected to the slide pin 502) to slide along the aligned elongated slot 515 of the brake pedal mounting bracket 508 (508L, 508R) and anti-rattle members 506 (506L, 506R). The brake pedal arm 512 is guided by the cam 564 and the cam members 562 during this sliding movement of the slide pin 502 (and the upper portion of the brake pedal arm 512 connected to the slide pin 502) along the aligned elongated slot 515 of the brake pedal mounting bracket 508 (508L, 508R) and anti-rattle members 506 (506L, 506R).

The sliding movement of the slide pin 502 (and the brake pedal arm 512 connected to the slide pin 502) along the aligned, elongated slots 515 of the brake pedal mounting bracket 508 (508L, 508R) and anti-rattle members 506 (506L, 506R) also enables the movement of the brake pedal 512 between the operating position and the stowed, non-operating position.

Comparing and referring to FIGS. 3a-3b, FIGS. 10-11, and also FIGS. 14-15, the connection of a portion of the drive connector 521 with first end portion 575 of the brake pedal arm 512; the spring(s) 597, the elongated openings 582 and 584, the connectors 587, 589 connecting the cam members 562L and 562R with the brake pedal mounting bracket 508L and 508R enabling the lateral movement of the cam members 562L and 562R (i.e., with the brake pedal arm 512 therebetween); and the cam members 562 and the cams 564 (564′, 564″) facilitating the guided or controlled movement of the brake pedal arm 512 together assist with positioning of the brake pedal arm 512 when the pedal assembly 500 is in its operational position. That is, these configurations of the brake pedal assembly 500 (and the resulting movements thereof) together extend the brake pedal 512 and its pedal plate 538 toward the driver D when the pedal assembly 500 is in its operational position.

Referring to FIGS. 2a, 3b, 6, 9, 10, 13, and 14, in the operating position of the brake pedal 512, the lead nut 514 is moved/positioned to be at/near a lower end position of the lead screw 572 and the slide pin 502 is moved/positioned to be at/near lower end position of the aligned, elongated slots 515 of the brake pedal mounting bracket 508 (508L, 508R) and anti-rattle members 506 (506L, 506R). Referring to FIGS. 2b, 7, 8, 12, and 15 in the stowed, non-operating position of the brake pedal 512, the lead nut 514 is moved/positioned to be at/near an upper end position of the lead screw 572 and the slide pin 502 is moved/positioned to be at/near the upper end position of the aligned, elongated slots 515 of the brake pedal mounting bracket 508 (508L, 508R) and anti-rattle members 506 (506L, 506R).

A controller (not shown) may be associated with the pedal assemblies 400, 500 for controlling and/or adjusting the positions of the respective pedals 412, 512. For example, the controller may drive the pedal assemblies 400, 500 between their operating and their stowed, non-operating positions. In one embodiment, when the driver D operates a switch in the vehicle, for example, the controller may command the motor 416, 516 to move and drive the pedal assemblies 400, 500 (e.g., between their operating and their stowed, non-operating positions). In another embodiment, the controller may determine whether the vehicle V is in the autonomous driving mode or is in the driver/non-autonomous mode and automatically command the motor 416, 516 to move and drive the pedal assemblies 400, 500 (e.g., between their operating and their stowed, non-operating positions) based on the determination.

In one embodiment, each of the accelerator pedal assembly 400 and the brake pedal assembly 500 includes a sensor for detecting the pivotal movement of their respective pedal arm. In one embodiment, each of accelerator pedal assembly 400 and the brake pedal assembly 500 includes a mechanism that links the respective pedal assembly to the position detection device/sensor.

In one embodiment, the sensor is a Brake Apply Sensor (BAS) device. As the brake pedal arm 512 rotates, the sensor is configured to electronically transmit the position of the brake pedal arm 512 (e.g., its angle to determine how much is applied) for use by the controller/processor or other device in the vehicle, as understood in the art.

In one embodiment, the sensor is configured to translate a mechanical output of the position of the respective pedal arm though the entire range of motion of the respective pedal arm. In one embodiment, the mechanical output is then configured to be translated into an electronic signal for use in various applications, for example, pedal application sensing, regenerative braking systems, brake light activation, cruise control deactivation, and/or next generation vehicles. In one embodiment, when the brakes are applied by the driver, the sensor information/signals are received by the controller/processor. The controller/processor is configured to process the sensor information and send further information/signals to other parts of the vehicle to control (i.e., turn on) brake lights and/or control (i.e., turn off) the cruise control.

Also, it should be noted that accelerator pedal assembly 400 and/or the brake pedal assembly 500 may also be used in combination with any number of sensing devices or sensors. For example, other additional or alternative sensing, electronic, or communication devices can be used with either or both pedal assemblies disclosed herein and are not limited to those that are illustrated in the Figures and described above.

In one embodiment, the two slot arrangement is shown and described with respect to the accelerator pedal assembly 400 and the cam and slot arrangement is shown and described with respect to the brake pedal assembly 500. In another embodiment, the two slot arrangement may be used for the brake pedal assembly 500 and the cam and slot arrangement may be used for the accelerator pedal assembly 400. In yet another embodiment, the two slot arrangement may be used for both the brake pedal assembly 500 and the accelerator pedal assembly 400. In yet another embodiment, the cam and slot arrangement may be used for both the accelerator pedal assembly 400 and the brake pedal assembly 500.

In one embodiment, each of the accelerator pedal assembly 400 and the brake pedal assembly 500 has a motor. In such an embodiment, the two motors are configured to be synchronized so that the brake pedal 512 and the accelerator pedal 412 are moved between their respective operating positions and their stowed, non-operating positions at the same time. In another embodiment, the accelerator pedal assembly 400 and the brake pedal assembly 500 may share a common motor or other drive source. In such an embodiment, for example, the motor/drive source on one pedal assembly can be kept, and its output can be connected to the lead screw for its pedal assembly as well as to the lead screw for the other pedal assembly, such as by a drive cable or any other suitable force transfer device.

The terms “pedal”, “pedal assembly”, or “pedal structure” used interchangeably throughout this specification are not intended to be limit to a specific type of pedal device. It can be used for a brake pedal, a clutch pedal, or an accelerator pedal. The pedal may be used with any functional system (e.g., mechanical or electro-mechanical system such as a brake system, transmission) of the vehicle. The method(s) of manufacturing parts of the pedals disclosed herein are not intended to be limiting, and may include single processes and/or secondary processes. For example, parts of the disclosed pedal assembly may be manufactured or formed via stamping, molding, piercing, punching, bending, and/or manual processes. Also, the materials used to manufacture the pedal assembly should not be limiting. The pedal and its parts could be made from one or more metal(s) such as steel (tubular or blade-type), or plastic materials, for example. The parts of the pedal assembly could also be made from a combination of such materials, e.g., both metal and plastic.

Also, the shape and design of the accelerator and brake pedal arms 412, 512 are not intended to be limiting. For example, in one embodiment, the accelerator and brake pedal arms 412, 512 can be a solid structure, a tubular structure, or include a channel in and/or along its structure (e.g., a “U” channel shape). Other designs, mountings, and structure shapes could be implemented in the herein disclosed pedal assembly 10 without departing from this disclosure, as would be understood to one of ordinary skill in the art.

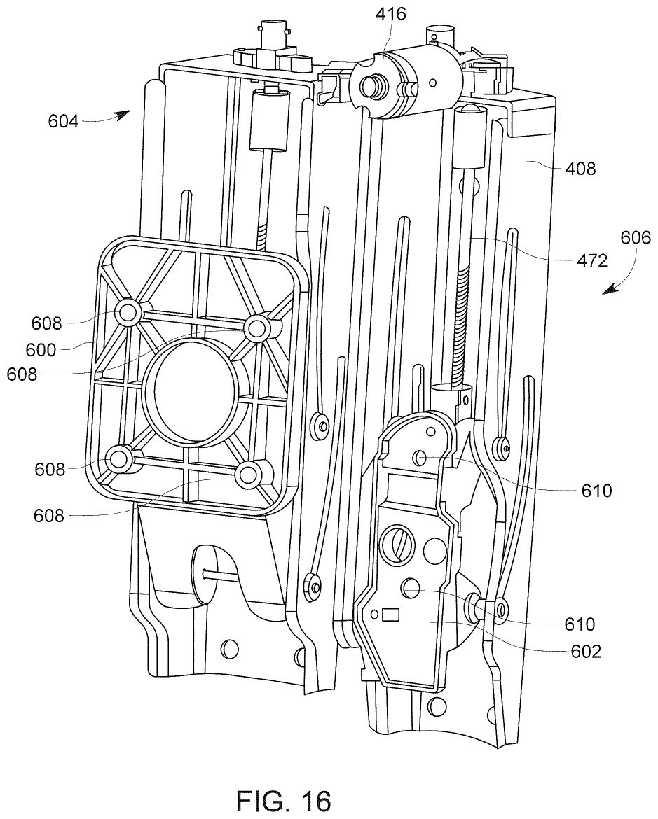

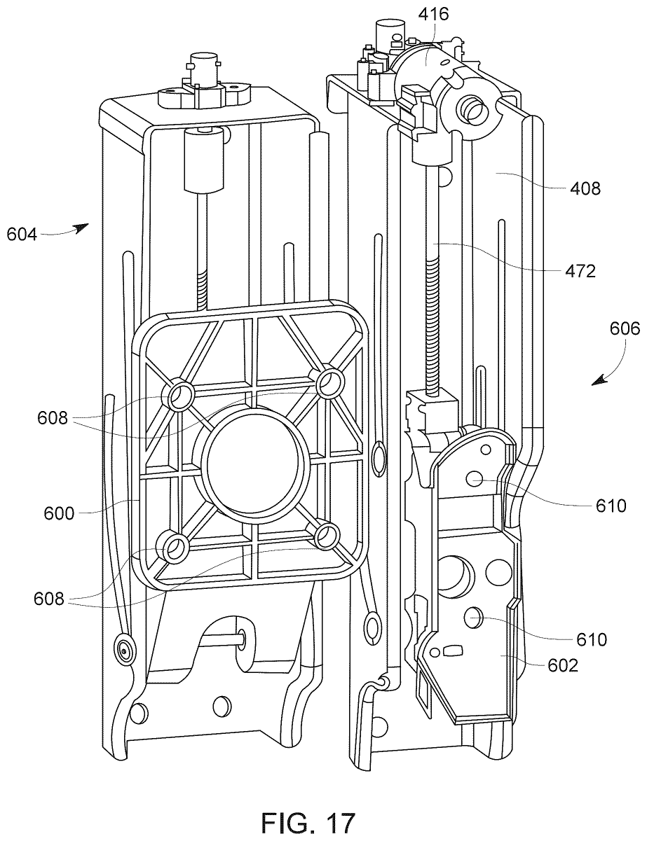

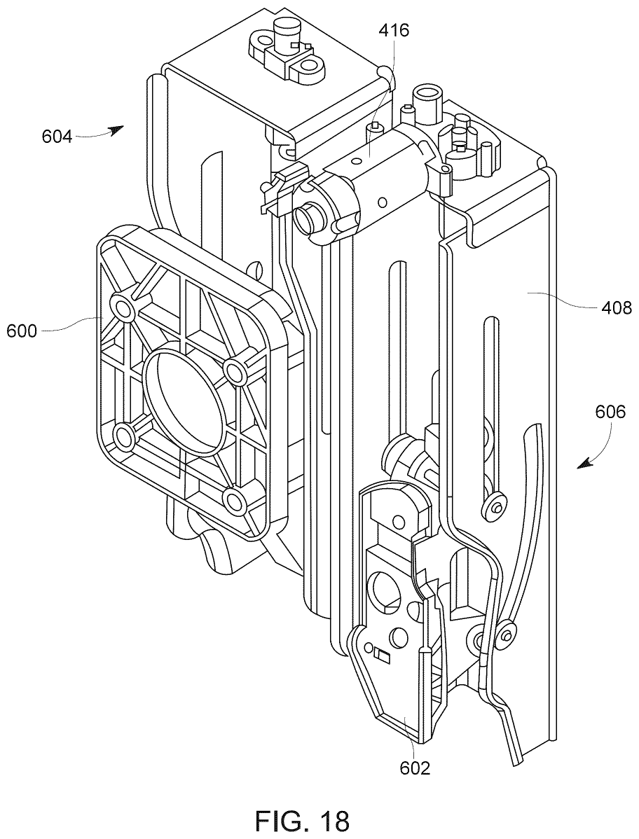

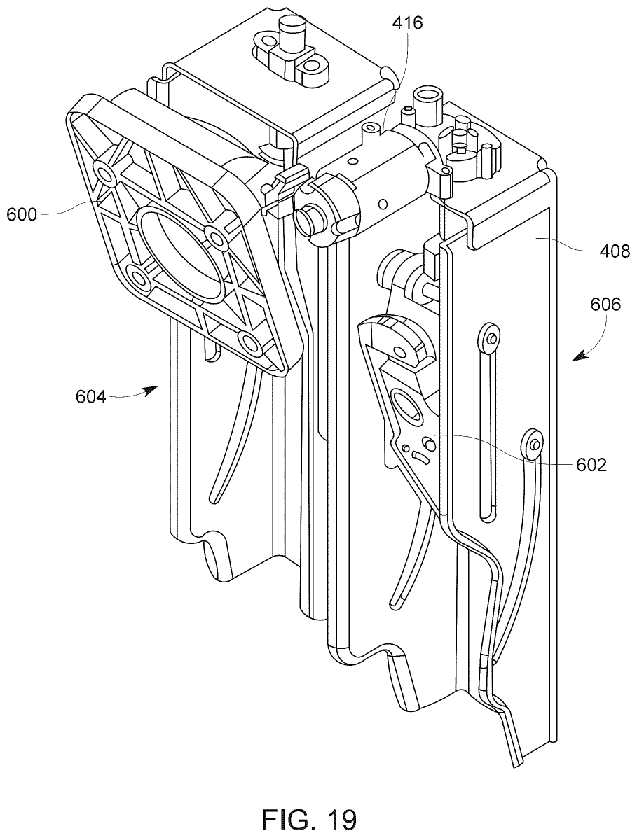

As mentioned above, the assembly can use one or more wired electrical connection (i.e., signals sent over hardwire circuitry) or wireless communication (e.g., signals) to control the relevant functional vehicle system (e.g., acceleration or braking). FIGS. 16-19 show an example of such an embodiment that can be used for mounting accelerator and brake pedal assemblies that communicate by wire or wirelessly. The construction is similar to other embodiments described above, and thus common reference numbers will be used where applicable for common or corresponding structures. In this embodiment, a brake pedal assembly mounting carrier or bracket 600 and an accelerator pedal assembly mounting carrier bracket 602 are included. An electronic brake pedal assembly (not shown) with the pedal arm and sensors included and pre-mounted to a bracket or other mount may be mounted to the bracket 600. Likewise, an electronic accelerator pedal assembly (not shown) with the pedal arm and sensors included and pre-mounted to a bracket or other mount may be mounted to the bracket 602. With this approach, each of the pedal assemblies can be mounted on it is respective bracket, such as in a modular fashion. This also enables the actuators 604, 606 (i.e., the structures responsible for the adjustment function as discussed above) to be constructed independently of the pedal assemblies, thus allowing the same adjustment mechanisms to be used with different pedal assemblies. To facilitate this, the brackets or carriers 600, 602 have fastener receiving openings 608, 610 for securing such pedal assemblies.

As illustrated, the accelerator pedal actuator 606 has the same basic design as the actuator 410 for the accelerator pedal assembly discussed above, in which the bracket 408 is configured to guide the accelerator pedal carrier 406 as it is moved between the deployed operating and retracted stowed positions. Similarly, the brake pedal actuator 604 has the same structures as the actuator 410 as well, although the dimensions between the two vary but the basic structure and operation are the same. Those details need not be repeated and this is apparent from the drawings. These assemblies may be separately mounted adjacent one another in the vehicle, or may be mounted together to a common bracket for easier installation.

One non-limiting advantage in this embodiment, or any other embodiment, of having the actuators 604, 606 for each pedal assembly separate is that the deployment stroke for positioning the corresponding pedal arm relative to its corresponding mounting bracket can be varied as between the two (or more). For example, brake pedal arms are typically positioned to present the brake pedal pad closer to the driver (i.e. further rearwardly with respect to the vehicle) in the deployed operating position, whereas the accelerator pedal arms are typically presented further from the driver (i.e., further forwardly) with respect to the vehicle. Also, brake pedal arms and accelerator pedal arms may be of different length, and/or their pedal pads may be of different shape (e.g., brake pedal pads tend to be laterally wider and vertically shorter, whereas accelerator pedal pads tend to be laterally narrower and vertically taller). Thus, the range and/or of motion between the deployed operating and retracted stowed positions may be varied by having different actuator kinematics for each pedal assembly.

As mentioned, a common motor or other drive source. In such an embodiment, for example, the motor/drive source on one pedal assembly can be kept, and its output can be connected to the lead screw for its pedal assembly as well as to the lead screw for the other pedal assembly, such as by a rotation drive cable, gear transfer, or any other suitable torque transfer device. For example, if the motor 416 that drives the lead screw 472 in the actuator 606 for the accelerator pedal assembly is retained as the single motor, the output from that motor can be connected to a corresponding lead screw in the actuator 604 for the brake pedal assembly. The reverse may be done (i.e. the single motor may be the one for moving the brake pedal arm), or the motor may be in any location and connection to each adjustment mechanism, such as by a rotation drive cable, gear transfer, or any other suitable torque transfer device. In this embodiment, or any other embodiment, an advantage of this is the reduced cost of using only one motor, and a difference in deployment/retraction strokes for moving the pedal arms can be accommodated by the mechanical design and kinematics of the respective actuators, as discussed above.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed is:

1. A pedal assembly for a vehicle, the vehicle is configured to be operated in either a non-autonomous driving mode in which the vehicle is driven by a driver or an autonomous driving mode in which the vehicle is autonomously driven, the pedal assembly comprising:
an accelerator pedal assembly having an accelerator pedal arm and an accelerator pedal mounting bracket;
a brake pedal assembly having a brake pedal arm and a brake pedal mounting bracket,
each of the accelerator pedal arm and the brake pedal arm comprising:
an elongated lever structure with a first end and a second end; and
a pedal plate provided on the second end of the elongated lever structure of the corresponding pedal arm for depression by a foot of the driver; and
an actuator operatively connected to the accelerator pedal assembly and the brake pedal assembly, the actuator being configured to adjust a position of the corresponding pedal arm relative to its corresponding mounting bracket between an operating position for when the vehicle is in the non-autonomous driving mode and a non-operating, stowed position for when the vehicle is in the autonomous driving mode, the non-operating, stowed position being at a raised position with respect to the operating position.

2. The pedal assembly according to claim 1, wherein the actuator comprises an actuator for the accelerator pedal assembly and an actuator for the brake pedal assembly.

3. The pedal assembly according to claim 1, wherein the accelerator pedal assembly comprises an accelerator pedal mounting bracket, the accelerator pedal arm being movably mounted to the accelerator pedal mounting bracket for movement between the operating and non-operating, stowed positions.

4. The pedal assembly according to claim 3, wherein the accelerator pedal assembly further comprises an accelerator pedal carrier member, the accelerator pedal arm being mounted to the accelerator pedal carrier,
wherein the accelerator pedal carrier member is movably mounted to the accelerator pedal mounting bracket for movement of the accelerator pedal arm between the operating and non-operating, stowed positions.

5. The pedal assembly according to claim 4, wherein said accelerator pedal assembly has a first pair of aligned, elongated slots configured to receive a first drive member therethrough and a second pair of aligned, elongated slots configured to receive a second drive member therethrough,
the first and second drive members being fixed to the accelerator pedal carrier.

6. The pedal assembly of claim 5, wherein the first pair of aligned, elongated slots has a substantially straight configuration and the second pair of aligned, elongated slots has a substantially curved configuration;
wherein at least a portion of the first pair of aligned, elongated slots extends and is positioned above the second pair of aligned, elongated slots.

7. The pedal assembly of claim 6, wherein each slot of the first pair of aligned, elongated slots is disposed on opposite, side walls of the accelerator pedal mounting bracket and each slot of the second pair of aligned, elongated slots is disposed on opposite, side walls of the accelerator pedal mounting bracket.

8. The pedal assembly of claim 6, wherein the curved configuration of the second pair of slots causes tilting of the accelerator pedal carrier member and the accelerator pedal connected thereto so as to extend the accelerator pedal arm toward a driver during movement to the operating position.

9. The pedal assembly of claim 8, wherein the actuator comprises a linear actuator for the accelerator pedal assembly.

10. The pedal assembly of claim 9, wherein the linear actuator includes connectors at a lower end thereof and the drive members are connected to connectors.

11. The pedal assembly of claim 10, wherein the linear actuator comprises a rotatable lead screw and a lead nut threaded on the lead screw, the connector being connected to opposing sides of the lead nut and to connect the drive members to the lead nut.

12. The pedal assembly according to claim 1, wherein the brake pedal assembly comprises a brake pedal mounting bracket, the brake pedal arm being movably mounted to the accelerator pedal mounting bracket for movement between the operating and non-operating, stowed positions.

13. The pedal assembly according to claim 12, wherein the brake pedal mounting bracket comprises elongated slots aligned with each other and wherein a slide pin is slidably received in the elongated slots for guiding the brake pedal arm.

14. The pedal assembly according to claim 13, further comprising a pair of cam members on opposing sides of the brake pedal arm and a pair of cams on opposing sides of the brake pedal arm, the cams and cam members and the slide pin and the elongated slots together being configured to facilitate guided or controlled movement of the brake pedal arm between its operating position and its non-operating, stowed position;
wherein the cam members and the cams guide the brake pedal arm to extend the brake pedal arm toward a driver during movement to the operating position.

15. The pedal assembly according to claim 14, wherein the actuator comprises a linear actuator for the brake pedal assembly.

16. The pedal assembly according to claim 15, wherein the linear actuator is connected to an upper end portion of the brake pedal arm.

17. The pedal assembly according to claim 16, wherein the linear actuator comprises a rotatable lead screw and a lead nut threaded on the lead screw, the connector being connected to opposing sides of the lead nut and to connect the drive members to the lead nut.
